(19) United States
(12) Patent Application Publication
(10) Pub. No.: US 2026/0265511 A1
(43) Pub. Date: Sep. 10, 2026

(54) THERMOSETTING RESIN COMPOSITION, RESIN SHEET, HEAT DISSIPATION PLATE, METHOD FOR MANUFACTURING RESIN SHEET, AND METHOD FOR MANUFACTURING HEAT DISSIPATION PLATE

(71) Applicant: Arisawa MFG. Co., Ltd., Niigata (JP)

(72) Inventors: Masae YANO, Niigata (JP); Saki ABE, Niigata (JP); Yuji TOYAMA, Niigata (JP)

(21) Appl. No.: 19/166,437

(22) PCT Filed: Mar. 18, 2024
(86) PCT No.: PCT/JP2024/010424

§ 371 Date: Sep. 17, 2025

(30) Foreign Application Priority Data
Apr. 14, 2023 (JP) 2023-066101

(51) Int. Cl. C08L 23/0869; B05D 1/02; B05D 1/28; C08K 7/04

(52) U.S. Cl. CPC C08L 23/0869; B05D 1/02; B05D 1/28; C08K 7/04; B05D 2202/25; B05D 2202/45; B05D 2301/00; B05D 2502/00; C08K 2201/003

(57) ABSTRACT

A thermosetting resin composition includes: an epoxy resin; a curing agent that cures the epoxy resin; an ethylene acrylic copolymer having a glass transition temperature of −30° C. or lower and having a carboxy group in a side chain; a first spherical filler having predetermined thermal conductivity and a predetermined average particle diameter; and a second spherical filler having predetermined thermal conductivity and a predetermined average particle diameter. A total weight proportion between the first spherical filler and the second spherical filler is 84 weight % or more and 90 weight % or less with respect to 100 weight % of total solids. A ratio between the first spherical filler and the second spherical filler is 55:45 to 85:15. A content of the ethylene acrylic copolymer is 700 parts by weight or more and 1,000 parts by weight or less with respect to 100 parts by weight of the epoxy resin.

### TECHNICAL FIELD

The present disclosure relates to a thermosetting resin composition, a resin sheet, a heat dissipation plate, a method for manufacturing a resin sheet, and a method for manufacturing a heat dissipation plate.

### BACKGROUND ART

When a device on which a great number of electronic parts such as an IC chip and a transistor is mounted is driven, a lot of heat is generated from the electronic parts. Then, when the generated heat cannot be efficiently dissipated, a function of the electronic part decreases due to an influence of the heat, and the device malfunctions. In order to prevent the malfunction, a substrate on which the electronic parts are installed includes, on a surface opposite to a surface on which the electronic parts are installed, a metal plate having high thermal conductivity via a resin sheet having an insulation property and a thermal conduction property. The metal plate can efficiently dissipate the heat generated from the electronic parts via the resin sheet.

For example, Patent Literature 1 discloses a metal base substrate including a metal plate, an insulating adhesive layer laminated on the metal plate, and a copper foil further laminated on the insulating adhesive layer. Further, Patent Literature 1 discloses an adhesive composition that can be used as the insulating adhesive layer and includes epoxy resin, a curing agent, a high polymer resin being compatible with the epoxy resin and having a weight-average molecular weight of 30,000 or more, a high polymer resin having a glass transition temperature of 0° C. or lower, having a reactive functional group, and having a weight-average molecular weight of 100,000 or more, a curing accelerator, and an inorganic filler having a small particle diameter.

### CITATION LIST

### Patent Literature

Patent Literature 1: Unexamined Japanese Patent Application Publication No. H10-242606

### SUMMARY OF INVENTION

### Technical Problem

Such a metal base substrate may have an inferior heat cycle characteristic. Specifically, when a heat cycle test is performed on the metal base substrate in which an electronic part is installed on a circuit acquired by etching the copper foil, the metal plate constituting the metal base substrate repeats expansion and contraction due to a temperature change. The repetition of the expansion and the contraction generates stress in the insulating adhesive layer laminated on the metal plate. However, the insulating adhesive layer cannot relax the stress, and thus the circuit moves in accordance with the expansion and the contraction of the metal plate. The movement of the circuit concentrates the stress to solder that connects the electronic part and the circuit, and a crack is more likely to occur in the solder. Thus, the above-described metal base substrate may have an inferior heat cycle characteristic. Furthermore, the inorganic filler included in the insulating adhesive layer has a small particle diameter, and thus the resin is more likely to be interposed between the fillers, and a thermal conduction property of the insulating adhesive layer is low.

The present disclosure has been made in view of the circumstances described above, and an object thereof is to provide a heat dissipation plate having an excellent heat cycle characteristic, a resin sheet having an excellent thermal conduction property, a thermosetting resin composition constituting a resin layer of the heat dissipation plate and the resin sheet, a method for manufacturing a resin sheet, and a method for manufacturing a heat dissipation plate.

### Solution to Problem

The present disclosure is as below.
[1] A thermosetting resin composition according to the present disclosure includes:
   an epoxy resin;
   a curing agent that cures the epoxy resin;
   an ethylene acrylic copolymer having a glass transition temperature of −30° C. or lower and having a carboxy group in a side chain;
   a first spherical filler having thermal conductivity of 20 W/m·K or more and an average particle diameter (D50) of 30 μm or more and 60 μm or less; and
   a second spherical filler having thermal conductivity of 20 W/m·K or more and an average particle diameter (D50) of 1 μm or more and 10 μm or less, wherein
   a total weight proportion between the first spherical filler and the second spherical filler is 84 weight % or more and 90 weight % or less with respect to 100 weight % of total solids,
   a ratio between the first spherical filler and the second spherical filler is 55:45 to 85:15, and
   a content of the ethylene acrylic copolymer is 700 parts by weight or more and 1,000 parts by weight or less with respect to 100 parts by weight of the epoxy resin.
[2] The first spherical filler may include at least one kind selected from a group consisting of alumina, boron nitride, aluminum nitride, magnesium oxide, zinc oxide, and silicon nitride.
[3] The second spherical filler may include at least one kind selected from a group consisting of alumina, boron nitride, aluminum nitride, magnesium oxide, zinc oxide, and silicon nitride.
[4] The thermosetting resin composition may further include an ion scavenger that captures an ion, and a content of the ion scavenger may be 40 parts by weight or more and 60 parts by weight or less with respect to 100 parts by weight of the epoxy resin.
[5] The thermosetting resin composition may have a thermal conductivity after curing of 2 W/m·K or more, a storage elastic modulus at −30° C. after curing of 7,000 MPa or less, a storage elastic modulus at 25° C. after curing of 10 MPa or more and 100 MPa or less, and a storage elastic modulus at 125° C. after curing of 1 MPa or more and 100 MPa or less.
[6] A resin sheet according to the present disclosure includes the thermosetting resin composition according to any one of [1] to [5].
[7] The cured state of the resin sheet may be a semi-cured state.
[8] A heat dissipation plate according to the present disclosure includes:
   a metal plate; and
   a resin layer including the thermosetting resin composition according to any one of [1] to [5],
   wherein the resin layer is provided on at least one surface of the metal plate.
[9] The cured state of the resin layer may be a semi-cured state.
[10] A method for manufacturing a resin sheet according to the present disclosure includes:
   preparing the thermosetting resin composition according to any one of [1] to [5];
   providing, on a film, a resin layer constituted by the thermosetting resin composition; and
   heating the film provided with the resin layer.
[11] A method for manufacturing a heat dissipation plate according to the present disclosure includes:
   laminating, on a metal plate, a resin layer of a resin sheet acquired by the method according to [10]; and
   heating and pressurizing the metal plate on which the resin layer is laminated.
[12] A method for manufacturing a heat dissipation plate according to the present disclosure includes:
   preparing the thermosetting resin composition according to any one of [1] to [5];
   providing, on a metal plate, a resin layer constituted by the thermosetting resin composition; and
   heating the metal plate provided with the resin layer.

### Advantageous Effects of Invention

The present disclosure can provide a heat dissipation plate having an excellent heat cycle characteristic, a resin sheet having an excellent thermal conduction property, a thermosetting resin composition constituting a resin layer of the heat dissipation plate and the resin sheet, a method for manufacturing a resin sheet, and a method for manufacturing a heat dissipation plate.

### BRIEF DESCRIPTION OF DRAWINGS

FIG. 1 is a schematic cross-sectional view of a resin sheet according to an embodiment;

FIG. 2 is a schematic cross-sectional view of a heat dissipation plate according to the embodiment; and

FIG. 3 is a schematic cross-sectional view of a substrate on which an electronic part is installed and including the heat dissipation plate according to the embodiment.

### DESCRIPTION OF EMBODIMENTS

Hereinafter, a thermosetting resin composition, a resin sheet, a heat dissipation plate, a method for manufacturing a resin sheet, and a method for manufacturing a heat dissipation plate according to an embodiment for implementing the present disclosure (hereinafter referred to as an embodiment) are described in detail. The embodiment below is an example for describing the present disclosure, and does not intend to limit the present disclosure to the following content. The present disclosure can be implemented while modifications are appropriately made within the scope of the purpose of the present disclosure. A part by weight used in the embodiment means, for example, a weight of only resin excluding a volatile component such as an organic solvent in resin, and a weight of a nonvolatile component. A semi-cured state (B stage) means a state where a curing reaction of the thermosetting resin composition proceeds halfway.

### Thermosetting Resin Composition

The thermosetting resin composition according to the embodiment includes an epoxy resin, a curing agent, an ethylene acrylic copolymer having a carboxy group in a side chain, a first spherical filler, and a second spherical filler. Further, the thermosetting resin composition according to the embodiment is suitably used as a resin composition constituting a resin sheet, and a resin composition of a resin layer constituting a heat dissipation plate.

Hereinafter, components included in the thermosetting resin composition according to the embodiment are described.

### (Epoxy Resin)

The epoxy resin may be able to cure the thermosetting resin composition by reacting with the curing agent, and, for example, has two or more epoxy groups in one molecule, and has an epoxy equivalent of 100 g/eq or more and 400 g/eq or less.

Examples of the epoxy resin include, for example, bisphenol A epoxy resin, bisphenol F epoxy resin, bisphenol S epoxy resin, novolac epoxy resin, amine epoxy resin, biphenyl epoxy resin, alicyclic epoxy resin, phenolic novolac epoxy resin, cresol novolac epoxy resin, naphthalene ring-containing epoxy resin, dicyclopentadiene epoxy resin, and the like. Among the epoxy resins described above, for example, novolac epoxy resin, phenolic novolac epoxy resin, cresol novolac epoxy resin, and bisphenol A epoxy resin are preferable from a viewpoint of increasing a dielectric breakdown voltage characteristic.

The epoxy resin may be used alone, or two or more kinds of the epoxy resins may be used together. Further, the epoxy resin may be dissolved by an organic solvent in advance in order to facilitate mixing with the other material included in the thermosetting resin composition.

### (Curing Agent)

The curing agent may be able to cure the epoxy resin, and examples of the curing agent include, for example, diaminodiphenylmethane (DDM), diaminodiphenyl sulfone (DDS), diaminodiphenyl ether (DDE), hexamethylenediamine, dicyandiamide, phenolic novolac phenolic resin, phenolic novolac cyanate ester resin, and the like. The curing agent is preferably dicyandiamide and diaminodiphenyl sulfone from a viewpoint of ease of control of a curing reaction. Further, the curing agent may be used alone, or two or more kinds of the curing agents may be used together.

A content of the curing agent may be able to cure the thermosetting resin composition, and, for example, 1 part by weight or more and 40 parts by weight or less with respect to 100 parts by weight of the epoxy resin are preferable, and 5 parts by weight or more and 40 parts by weight or less are more preferable. In this way, a dielectric breakdown voltage characteristic and heat resistance after the thermosetting resin composition is cured can be improved. Further, a heat cycle characteristic of the resin sheet and the heat dissipation plate constituted by the resin composition can be improved.

An equivalent of the curing agent may be able to cure the thermosetting resin composition, and, for example, 0.1 equivalent or more and 0.8 equivalent or less are preferable with respect to 1 equivalent of an epoxy group included in the epoxy resin, 0.1 equivalent or more and 0.6 equivalent or less are more preferable, and 0.2 equivalent or more and 0.4 equivalent or less are further preferable. In this way, a dielectric breakdown voltage characteristic and heat resistance after the thermosetting resin composition is cured can be improved. Further, a heat cycle characteristic of the heat dissipation plate using the resin composition can be improved.

### (Ethylene Acrylic Copolymer Having Carboxy Group in Side Chain)

Examples of the ethylene acrylic copolymer having the carboxy group in the side chain include a (meth)acrylic acid ester copolymer having an ethylene structure in a main chain and having a carboxy group in a side chain. A glass transition temperature of the ethylene acrylic copolymer having the carboxy group in the side chain is −30° C. or lower, preferably −35° C. or lower, and more preferably −40° C. or lower from a viewpoint of relaxing stress generated during a heat cycle. Herein, the (meth)acrylic acid ester copolymer means an acrylic acid ester copolymer or a methacrylic acid ester copolymer. Further, the glass transition temperature can be measured by a differential scanning calorimetry (DSC) method.

The (meth)acrylic acid ester copolymer having the carboxy group in the side chain is constituted by, for example, two or more kinds of monomers. Examples of the monomer constituting the copolymer include, for example, a (meth)acrylic acid ester monomer, a carboxy group-containing monomer, an anhydride of a carboxy group-containing monomer, and the like. Herein, the (meth)acrylic acid ester monomer means an acrylic acid ester monomer or a methacrylic acid ester monomer.

The ethylene acrylic copolymer having the carboxy group in the side chain is acquired by polymerizing the monomers described above, and thus the ethylene structure can be introduced into the main chain of the copolymer. Examples of the introduction method include, for example, introduction methods by a Ziegler-Natta catalytic polymerization method, a metallocene catalytic polymerization method, a Versipol catalytic polymerization method, and a free radical polymerization method.

Examples of the (meth)acrylic acid ester monomer include, for example, (meth)acrylic acid alkyl ester such as (meth)acrylic acid methyl, (meth)acrylic acid ethyl, (meth)acrylic acid-n-butyl, and (meth)acrylic acid-2-ethylhexyl; (meth)acrylic acid hydroxyalkyl ester such as (meth)acrylic acid hydroxyethyl; (meth)acrylic acid N,N-dimethylaminoalkyl such as (meth)acrylic acid N,N-dimethylaminomethyl; and epoxy group-containing (meth)acrylic acid ester such as (meth)acrylic acid glycidyl. Note that the (meth)acrylic acid methyl means acrylic acid methyl or methacrylic acid methyl. Further, the (meth)acrylic acid means acrylic acid or methacrylic acid. The same holds true for the following.

Examples of the carboxy group-containing monomer include, for example, (meth)acrylic acid, fumaric acid, and maleic acid.

Examples of the anhydride of the carboxy group-containing monomer include, for example, anhydrides of (meth)acrylic acid, maleic acid, and the like.

A weight-average molecular weight of the ethylene acrylic copolymer having the carboxy group in the side chain is, for example, 100,000 or more and 400,000 or less, and preferably 150,000 or more and 300,000 or less from a viewpoint of preventing stress from being generated in the resin layer of the heat dissipation plate. Herein, the weight-average molecular weight can be measured by gel permeation chromatography (GPC) by using standard polystyrene having an average molecular weight of about 500 or more and about 1,000,000 or less.

A content of the ethylene acrylic copolymer having the carboxy group in the side chain is, for example, 700 parts by weight or more and 1,000 parts by weight or less with respect to 100 parts by weight of the epoxy resin, and preferably 700 parts by weight or more and 900 parts by weight or less from a viewpoint of preventing stress from being generated in the resin layer of the heat dissipation plate and a viewpoint of a thermal conduction property.

A content of the carboxy group is, for example, preferably 3 mgKOH/g or more and 30 mgKOH/g or less, and more preferably 10 mgKOH/g or more and 30 mgKOH/g or less from a viewpoint of preventing stress from being generated in the resin layer of the heat dissipation plate. The content of the carboxy group can be measured by a titration method by a potassium hydroxide aqueous solution of 0.1 N.

Examples of articles on the market of the ethylene acrylic copolymer having the carboxy group in the side chain include, for example, VMX4017 made by DuPont de Nemours, Inc.

### (First Spherical Filler)

An average particle diameter (D50) of the first spherical filler is 30 μm or more and 60 μm or less. The average particle diameter (D50) is 30 μm or more and 60 μm or less, and thus the first spherical filler is less likely to protrude from a surface of the resin layer. In this way, smoothness of the surface of the resin layer is improved. Further, the particle diameter described above is set, and thus a network between the first spherical fillers is more likely to be provided, and a thermal conduction property of the resin layer is improved.

Thermal conductivity of the first spherical filler is 20 W/m·K or more from a viewpoint of improving a thermal conduction property of the resin layer of the heat dissipation plate. The first spherical filler may be a filler having an excellent insulation property and an excellent thermal conduction property, and is constituted by at least one kind selected from a group consisting of alumina, boron nitride, aluminum nitride, magnesium oxide, zinc oxide, and silicon nitride, and alumina is more preferable. Herein, the average particle diameter (D50) refers to a particle diameter when particles having a smaller particle diameter are counted in a particle size distribution with reference to volume and the accumulated volume reaches 50% of the entire volume. The particle diameter can be measured by dynamic light scattering.

### (Second Spherical Filler)

An average particle diameter (D50) of the second spherical filler is 1 μm or more and 10 μm or less, and more preferably 1 μm or more and 5 μm or less. The second spherical filler having such an average particle diameter (D50) fills a gap between one first spherical filler and the other first spherical filler in such a way as to fill in the gap. This contributes to an improvement in a thermal conduction property of the resin layer described below. Thermal conductivity of the second spherical filler is 20 W/m·K or more from a viewpoint of improving a thermal conduction property of the resin layer constituted by the thermosetting resin composition. The second spherical filler may be a filler having an excellent insulation property and an excellent thermal conduction property, and is constituted by at least one kind selected from a group consisting of alumina, boron nitride, aluminum nitride, magnesium oxide, zinc oxide, and silicon nitride, and alumina is more preferable.

A total weight proportion between the first spherical filler and the second spherical filler described above is 84 weight % or more and 90 weight % or less with respect to 100 weight % of total solids included in the thermosetting resin composition, preferably 85 weight % or more and 90 weight % or less, and more preferably 85 weight % or more and 89 weight % or less from a viewpoint of improving a thermal conduction property, a heat cycle characteristic, and a dielectric breakdown voltage characteristic. Further, a ratio between the first spherical filler and the second spherical filler is 55:45 to 85:15, and preferably 55:45 to 65:35 from a viewpoint of preventing stress from being generated in the resin layer of the heat dissipation plate.

The resin layer constituted by the thermosetting resin composition including the materials described above and having the configurations such as the proportion described above has the following effects. The resin layer constituted by the thermosetting resin composition in which the materials described above are uniformly mixed is filled with the second spherical filler that fills in the gap between one first spherical filler and the other first spherical filler. A network of the spherical fillers is minutely provided in the resin layer by the spherical fillers filling without a gap. As a result, the resin layer constituted by the thermosetting resin composition according to the present embodiment has an excellent thermal conduction property.

Furthermore, the thermosetting resin composition according to the present embodiment includes the ethylene acrylic copolymer having a glass transition temperature of −30° C. or lower and the spherical fillers described above, and can thus reduce generation of stress. In other words, the heat dissipation plate including the resin layer constituted by such a thermosetting resin composition can reduce generation of stress in the resin layer even when a temperature change occurs, and thus the heat dissipation plate has an excellent heat cycle characteristic.

Note that the first spherical filler and the second spherical filler do not need to be a true sphere, and may be a filler having a shape with little unevenness of a surface to an extent that stress generated in the resin layer can be released. Further, the spherical filler also includes, for example, a filler constituted by a polyhedron having 12 faces or more. Further, materials of the first spherical filler and the second spherical filler may be the same or may be different.

### (Other Component)

The thermosetting resin composition according to the embodiment may include an ion scavenger that captures an ion generated in the thermosetting resin composition. By including the ion scavenger, an ion present in the resin composition is reduced and a dielectric breakdown voltage characteristic is improved. A content of the ion scavenger included in the thermosetting resin composition is 40 parts by weight or more and 60 parts by weight or less with respect to 100 parts by weight of the epoxy resin.

The thermosetting resin composition according to the embodiment may further contain the other additive. Examples of the other additive include an imidazole-based curing accelerator such as 2-methylimidazole, 2-undecylimidazole, 1,2-dimethylimidazole, 2-ethyl-4-methylimidazole, and N-benzyl-2-methylimidazole; a Lewis acid complex curing accelerator such as boron trifluoride monoethylamine and boron trifluoride diethylamine; a curing accelerator such as polyamine and melamine resin; a dispersant; a softener; a heat aging inhibitor; a silane coupling agent; and the like.

As described above, the thermosetting resin composition according to the embodiment is acquired by mixing the materials described above.

Thermal conductivity of the thermosetting resin composition after curing is 2 W/m·K or more, and a thermal conduction property is excellent. The thermosetting resin composition has a storage elastic modulus at −30° C. after curing of 7,000 MPa or less, a storage elastic modulus at 25° C. after curing of 10 MPa or more and 100 MPa or less, and a storage elastic modulus at 125° C. after curing of 1 MPa or more and 100 MPa or less. The heat dissipation plate including the resin layer constituted by such a thermosetting resin composition and a metal plate has an excellent heat cycle characteristic in a heat cycle test in which the heat dissipation plate is alternately and repeatedly subjected to two temperature atmospheres of a low-temperature atmosphere between −20° C. and −40° C. and a high-temperature atmosphere between 100° C. and 175° C.

Note that a condition for curing the thermosetting resin composition is, for example, 1 hour or longer at 160° C. or higher and 200° C. or lower. Thermal conductivity of the thermosetting resin composition can be measured by a laser flash method by using a laser flash analyzer (LFA) device. A storage elastic modulus of the thermosetting resin composition can be measured by a dynamic viscoelasticity measurement method.

Next, the resin sheet according to the embodiment is described.

### [Resin Sheet]

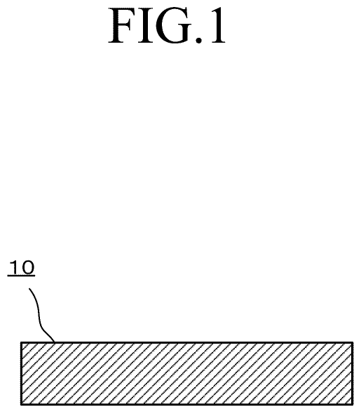

As illustrated in FIG. 1, a resin sheet 10 according to the embodiment is constituted by the thermosetting resin composition according to the embodiment, and has a sheet shape. A cured state of the resin sheet 10 is a semi-cured state.

A thickness of the resin sheet 10 has adhesiveness, may have an excellent conduction property and an excellent heat cycle characteristic when the resin sheet 10 is used as a resin layer of a heat dissipation plate, and is, for example, 80 μm or more and 500 μm or less.

The resin sheet 10 is produced by the following procedures, for example. A thermosetting resin composition is prepared by adding and mixing a predetermined amount of an epoxy resin, a curing agent, an ethylene acrylic copolymer, a first spherical filler, and a second spherical filler in a container. The thermosetting resin composition is applied to a separate film by using, for example, a coating device, and is heated. After cooling, the separate film provided with the resin layer constituted by the thermosetting resin composition, i.e., the resin sheet 10 is acquired. The acquired resin sheet 10 is used by peeling the separate film at the time of use. A cured state of the resin sheet 10 is a semi-cured state. A curing condition is, for example, 100° C. or higher and 250° C. or lower, and 5 seconds or longer and 30 minutes or shorter, and can be adjusted according to a thickness of the resin sheet 10.

A thickness of the separate film used when the resin sheet 10 is produced may be easy to handle, and is, for example, 25 μm or more and 100 μm or less. A thickness of the separate film is decided according to a thickness of the resin layer. Examples of a material of the separate film include, for example, polyethylene, polypropylene, polyimide, polyamide, polyethylene naphthalate, and polyethylene terephthalate. Mold releasing processing may be executed on a surface of the separate film from a viewpoint of making it easy to peel the separate film from the resin sheet 10. Examples of a processing agent of the mold releasing processing include, for example, a silicone-based processing agent and a fluorine-based processing agent.

Note that the resin sheet 10 may have a different configuration. Examples of the resin sheet 10 having a different configuration include a double-sided resin sheet in which a resin layer is provided on both sides of a film from a viewpoint of increasing rigidity and electrical insulating reliability. Examples of a material of the film include, for example, polyimide, polyamide, and polyethylene naphthalate from a viewpoint of increasing heat resistance and a viewpoint of increasing rigidity of the resin sheet.

The resin sheet according to the embodiment is described above.

Next, the heat dissipation plate according to the embodiment is described.

### [Heat Dissipation Plate]

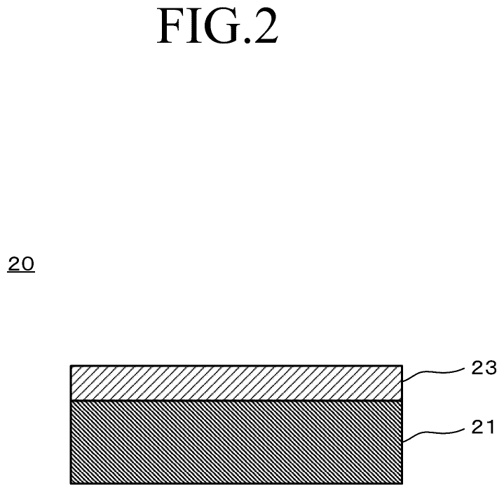

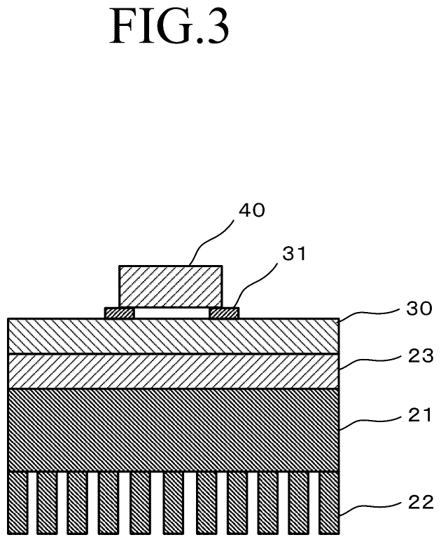

As illustrated in FIG. 2, a heat dissipation plate 20 according to the embodiment includes a metal plate 21, and a resin layer 23 constituted by the thermosetting resin composition according to the embodiment. The resin layer 23 is provided on at least one surface of the metal plate 21. A cured state of the resin layer 23 is a semi-cured state. As illustrated in FIG. 3, an electronic part 40 is installed on a substrate 30 via a circuit 31 provided on the substrate 30. The substrate 30 is provided on a surface of the resin layer 23 on an opposite side to the surface on which the metal plate 21 is provided. A thickness of the resin layer 23 may be able to keep insulation between the substrate 30 and the metal plate 21, and is, for example, 80 μm or more and 500 μm or less, and preferably 100 μm or more and 200 μm or less.

The metal plate 21 may be able to efficiently dissipate heat generated from the electronic part 40 installed on the substrate 30, and is preferably constituted by metal having high thermal conductivity. Examples of the metal having high thermal conductivity include, for example, copper, aluminum, stainless steel, and the like. Particularly, copper and aluminum having excellent processability and high thermal conductivity are preferable.

A thickness of the metal plate 21 may be easy to process, and is, for example, 9 μm or more and 10 mm or less, and preferably 500 μm or more and 2 mm or less. Note that the metal plate 21 also includes a metal foil.

As illustrated in FIG. 3, the metal plate 21 may be provided with a plurality of fins 22 on a surface on an opposite side to a surface on which the resin layer 23 is provided. The metal plate 21 provided with the plurality of fins 22 is also called a heat sink.

A thickness of the metal plate 21 provided with the plurality of fins 22 is, for example, 0.3 mm or more and 50 mm or less. The fin 22 is constituted by, for example, a plate and a stick. A height of the fin 22 is, for example, 1 mm or more and 100 mm or less. A thickness of a plate-shaped fin is, for example, 0.2 mm or more and 9 mm or less, and is preferably thinner than a thickness of the metal plate 21. Further, the plate-shaped fin is preferably smaller than the metal plate 21. A stick-shaped fin has, for example, a quadrangular or circular cross-sectional shape in a direction orthogonal to a longitudinal direction of the fin.

The entire surface of the fin 22 may be covered with the thermosetting resin composition according to the embodiment, and only a part of the surface of the fin 22 may be covered with the thermosetting resin composition according to the embodiment.

The heat dissipation plate 20 is produced by the following procedures, for example. The metal plate 21 and the resin sheet 10 as the resin layer 23 are prepared. Before the resin sheet 10 is laminated on the metal plate 21, the separate film is peeled from a resin surface of the resin sheet 10. Next, the resin sheet 10 is laminated on the metal plate 21 in such a way that the resin sheet 10 and the metal plate 21 are in contact. Then, the metal plate 21 on which the resin sheet 10 is laminated is heated and pressurized in a condition of 0.3 MPa or more and 10 MPa or less, 100° C. or higher and 250° C. or lower, and 5 seconds or longer and 30 minutes or shorter. After cooling, the heat dissipation plate 20 is acquired. A condition of heating and pressurization can be adjusted according to a thickness of the resin layer 23.

Examples of a different method for manufacturing the heat dissipation plate 20 include, for example, the following method. A thermosetting resin composition is prepared by adding and mixing a predetermined amount of an epoxy resin, a curing agent, an ethylene acrylic copolymer, a first spherical filler, and a second spherical filler in a container. Further, the metal plate 21 is prepared. Next, the thermosetting resin composition is applied to the metal plate 21 by using, for example, a coating device, and is heated. After cooling, the metal plate 21 on which the resin layer 23 is provided, i.e., the heat dissipation plate 20 is acquired. A heating condition is, for example, 100° C. or higher and 250° C. or lower, and 5 seconds or longer and 30 minutes or shorter. The heating condition can be adjusted according to a thickness of the resin layer 23.

The heat dissipation plate according to the embodiment is described above.

Note that an organic solvent may be used when the thermosetting resin composition according to the embodiment is prepared. Examples of the organic solvent include, for example, alcohols such as methanol and ethanol; glycols such as ethylene glycol and propylene glycol; glycol monoalkyl ethers such as ethylene glycol monomethyl ether and ethylene glycol monoethyl ether; glycol dialkyl ethyl such as ethylene glycol dimethyl ether and ethylene glycol diethyl ether; alkyl esters such as methyl acetate, ethyl acetate, propyl acetate, and methyl acetoacetate; ketones such as acetone, methyl ethyl ketone, methyl isobutyl ketone, and cyclohexanone; aromatic hydrocarbons such as benzene, toluene, xylene, and ethyl benzene; aliphatic hydrocarbons such as hexane, cyclohexane, and octane; amides such as dimethylformamide, dimethylacetamide, and N-methylpyrrolidone; cyclic ethers such as tetrahydrofuran and dioxane; and the like.

Further, examples of a device used when the resin sheet 10 and the resin layer 23 of the heat dissipation plate 20 according to the embodiment are provided include, for example, a coating device. Examples of the coating device include, for example, a publicly known coater such as, for example, a die coater and a comma coater.

### Example

The present disclosure is described in more detail by examples below. The present disclosure is not limited in any way by the examples below.

The following component was used as each component included in a thermosetting resin composition in examples and comparative examples.

### (Epoxy Resin)

(1) jER (registered trademark) 828: bisphenol A epoxy resin, epoxy equivalent of 190 g/eq, made by Mitsubishi Chemical Corporation.

### (Curing Agent)

Seikacure-S: 4,4′-DDS (4,4′-diaminodiphenyl sulfone), amine valence of 62 g/eq, made by Wakayama Seika Kogyo Co., Ltd.

### (Acrylic Copolymer)

(1) VMX4017: ethylene acrylic copolymer having carboxy group in side chain, glass transition temperature of −41° C., made by DuPont de Nemours, Inc.,
(2) GLS: ethylene acrylic copolymer having carboxy group in side chain, glass transition temperature of −24° C., made by DuPont de Nemours, Inc.,
(3) 1HY-3006Y: acrylic copolymer having carboxy group in side chain (not including ethylene in main chain), weight-average molecular weight of about 280,000, glass transition temperature of −53° C., made by Taisei Fine Chemical Co., Ltd., and
(4) 1HY-2002M: acrylic copolymer having carboxy group in side chain (not including ethylene in main chain), weight-average molecular weight of about 280,000, glass transition temperature of −3° C., made by Taisei Fine Chemical Co., Ltd.

### (Ion Scavenger)

KW-2200: magnesium oxide-aluminium oxide solid solution, made by Kyowa Chemical Industry Co., Ltd.

### (Filler)

(1) DAM-45: spherical alumina, average particle diameter (D50) of 45 μm, thermal conductivity of 36 W/m·K, made by Denka Company Limited,
(2) DAM-20: spherical alumina, average particle diameter (D50) of 20 μm, thermal conductivity of 36 W/m·K, made by Denka Company Limited,
(3) DAM-10: spherical alumina, average particle diameter (D50) of 10 μm, thermal conductivity of 36 W/m·K, made by Denka Company Limited,
(4) DAM-03: spherical alumina, average particle diameter (D50) of 3 μm, thermal conductivity of 36 W/m·K, made by Denka Company Limited,
(5) AA18: nonspherical alumina, average particle diameter (D50) of 20 μm, thermal conductivity of 36 W/m·K, made by SUMITOMO CHEMICAL COMPANY, LIMITED,
(6) AS-50: nonspherical alumina, average particle diameter (D50) of 10 μm, thermal conductivity of 36 W/m. K, made by Showa Denko K.K.,
(7) LS-210: nonspherical alumina, average particle diameter (D50) of 2 μm, thermal conductivity of 36 W/m·K, made by Nippon Light Metal Company, Ltd.,
(8) AO-502: spherical alumina, average particle diameter (D50) of 0.25 μm, thermal conductivity of 36 W/m. K, made by ADMATECHS COMPANY LIMITED,
(9) FAN-f50-A1: spherical aluminum nitride, average particle diameter (D50) of 50 μm, thermal conductivity of 170 W/m·K, made by Furukawa Denshi Co., Ltd.,
(10) FAN-f05: polyhedral shape, aluminum nitride, average particle diameter (D50) of 5.0 μm, thermal conductivity of 170 W/m·K, made by Furukawa Denshi Co., Ltd.,
(11) FB-40R: spherical silica, average particle diameter (D50) of 40 μm, thermal conductivity of 1 W/m·K, made by Denka Company Limited, and
(12) FB-5SDC: spherical silica, average particle diameter (D50) of 3.0 μm, thermal conductivity of 1 W/m·K, made by Denka Company Limited.

### Example 1

First, a thermosetting resin composition was prepared. The resin sheet 10 constituted by the thermosetting resin composition was produced. Next, a storage elastic modulus of the thermosetting resin composition after curing was measured by using the resin sheet 10. Further, thermal conductivity of the resin sheet 10 was measured. Furthermore, a heat cycle test was performed on the heat dissipation plate 20 using the resin sheet 10.

### (Preparation of Thermosetting Resin Composition)

100 parts by weight of jER (registered trademark) 828, 10 parts by weight of Seikacure-S, 800 parts by weight of VMX4017, 4,006 parts by weight of DAM-45, 2,670 parts by weight of DAM-03, and 500 parts by weight of methyl ethyl ketone as an organic solvent were added to a container. Subsequently, these components were mixed at a room temperature, and the thermosetting resin composition was acquired.

### (Measurement of Storage Elastic Modulus)

A measurement sample was produced for performing measurement of a storage elastic modulus of the acquired thermosetting resin composition. First, the thermosetting resin composition was applied to a mold releasing processed surface of a mold releasing polyethylene terephthalate (PET) film (PET5011 made by LINTEC Corporation) having a thickness of 50 μm in such a way that a thickness after pressing was 100 μm, and the mold releasing processed surface was covered with a different mold separating PET film. Subsequently, in a condition of 180° C., 3 MPa, and 60 minutes, a laminated body in which the mold releasing PET film, the thermosetting resin composition, and the mold releasing PET film were laminated in this order was heated and pressurized. After cooling, the resin sheet 10 after curing having a thickness of 100 μm was acquired. The acquired resin sheet 10 after curing was cut into a rectangular shape having a length of 30 mm and a width of 4 mm, and a measurement sample of a storage elastic modulus was acquired.

The storage elastic modulus was measured by a dynamic viscoelasticity measurement method by using RSA-G2 (made by TA Instruments Japan Inc.). A measurement condition was a temperature range from −50° C. to 200° C., a rate of temperature rise of 10° C./min, a frequency of 1 Hz, a distance between chucks of 20 mm, and a tensile mode. A storage elastic modulus of the thermosetting resin composition after curing in Example 1 was 325 MPa at −30° C., 15 MPa at 25° C., and 8 MPa at 125° C.

### (Production of Resin Sheet 10)

The thermosetting resin composition was applied to a mold releasing processed surface of a mold releasing PET film (PET5011 made by LINTEC Corporation) having a thickness of 50 μm in such a way that a thickness after heating was 100 μm. Subsequently, heating was performed at 120° C. for 10 minutes, cooling was performed, and the resin sheet 10 provided with the mold releasing PET film on one side was then acquired. A cured state of the resin sheet 10 was a semi-cured state (B stage).

### <Thermal Conductivity>

A heat diffusion coefficient (a), specific heat (Cp), and density (p) of a measurement sample of thermal conductivity were measured, and thermal conductivity was calculated from the following equation.

$$Thermal conductivity [ W / ( m \cdot K ) ] = α [ {mm}^{2} / s ] \times Cp [ J / g \cdot K ] \times ρ [ g / {cm}^{3} ]$$

α [mm²/s]: heat diffusion coefficient,
Cp [J/g·K]: specific heat, and
ρ [g/cm³]: density.
Evaluation criteria were as follows.
Good: 2 W/(m·K) or more, and
Poor: less than 2 W/(m·K).

Note that a measurement sample of thermal conductivity whose evaluation result was Good had an excellent thermal conduction property.

### (Production of Measurement Sample of Thermal Conductivity)

Two resin sheets 10 provided with the mold releasing PET film on one side were prepared and laminated in such a way that resin surfaces of the two sheets were in contact, and a laminated body was acquired. The laminated body was heated and pressurized in a condition of 185° C., 5 MPa, and 180 minutes. Subsequently, the mold releasing PET film was peeled from the laminated body, and a measurement sample of thermal conductivity was acquired.

### (Measurement of Heat Diffusion Coefficient (α))

A laser flash method for measuring a temperature change in the other surface when one surface of the measurement sample of thermal conductivity was irradiated with pulse light was adopted. Further, the acquired measurement data were analyzed by a halftime method, and a heat diffusion coefficient (α) was obtained. LFA447 made by NETZSCH Japan K.K. was used as a measurement apparatus, and measurement was performed under a condition of 25° C.

### (Measurement of Specific Heat (Cp))

Cp (J/g·K) of the measurement sample of thermal conductivity was obtained by a differential scanning calorimetry method (DSC method) in conformity with JIS K7123. Q200 made by TA Instruments Japan Inc. was used as a measurement apparatus, and measurement was performed under a condition of a rate of temperature rise of 10° C./min and a temperature range from −30° C. to 50° C.

### (Measurement of Density (p))

An immersion method was adopted for measurement of density (p). AUX220 and SMK-401 made by SHIMADZU CORPORATION were used as a measurement apparatus.

As described above, a numerical value of the heat diffusion coefficient (α), a numerical value of the specific heat (Cp), and a numerical value of the density (ρ) that have each been obtained were substituted in the equation of the thermal conductivity, and the thermal conductivity was calculated. The thermal conductivity of the resin sheet 10 in Example 1 was 2.9 W/(m·K), and the evaluation was Good. It has been shown that the resin sheet 10 in Example 1 had an excellent thermal conduction property.

### <Heat Cycle Test>

Next, a heat cycle test was performed on the resin sheet 10 in Example 1. A measurement sample of a heat cycle test was produced as follows.

### (Production of Measurement Sample of Heat Cycle Test)

A rolled copper foil (BHY made by JX Nippon Mining & Metals Corp.) that had a thickness of 35 μm and was intended to represent the substrate 30 and the circuit 31 was prepared. The rolled copper foil and the resin sheet 10 were laminated in such a way that a rough surface of the rolled copper foil and a resin surface of the resin sheet 10 were in contact. Next, an aluminum foil (soft single-sided aluminum foil made by Toyo Aluminium K.K.) corresponding to the metal plate 21 and having a thickness of 50 μm and the resin sheet 10 were laminated in such a way that a rough surface of the aluminum foil was in contact with a resin surface opposite to the resin surface on which the rolled copper foil was laminated, and a laminated body was acquired. The acquired laminated body had a configuration in which the rolled copper foil, the resin sheet 10, and the aluminum foil were laminated in this order. Next, the laminated body was heated and pressurized in a condition of 180° C., 5 MPa, and 60 minutes. After cooling, the laminated body was cut into a rectangular shape of 10 mm×50 mm. Note that the resin sheet 10 was used after the mold releasing PET film was peeled.

Next, the laminated body was put in a container in order to provide a resin layer that protected a surface of the laminated body, resin was put in such a way that the entire surface of the laminated body was covered with the resin, and the resin was hardened by heating at 100° C. for 24 hours. After cooling, the laminated body covered with the resin was taken out of the container, and the laminated body covered with the resin was polished until an end surface (section) of the laminated body was exposed. The configuration in which the rolled copper foil, the resin sheet, and the aluminum foil were laminated in this order was able to be confirmed in the end surface (section) of the laminated body after polishing. This was set as a measurement sample of a heat cycle test. Note that the used resin was a two-part epoxy adhesive (Denatite made by Nagase ChemteX Corporation). Specifically, the resin acquired by mixing a main agent (XNR5021) and a curing agent (XNH5021) was put in the container in which the laminated body was put.

The measurement sample of a heat cycle test was put in a thermal shock testing machine (TSA-72EL-A made by ESPEC CORP.). After the sample was put, a temperature in the testing machine was cooled to −40° C., the temperature was maintained for 30 minutes, the temperature was then raised to 150° C., and the temperature was maintained for 30 minutes. This was set as 1 cycle, and 3,000 cycles were performed.

### (Evaluation)

The end surface (section) of the laminated body after polishing after 3,000 cycles were performed was observed by an optical microscope (VHX-8000 made by KEYENCE CORPORATION), and evaluation was performed by the following criteria.
Good: occurrence of crack was not confirmed in copper foil layer when end surface (section) of laminated body was checked, and
Poor: occurrence of crack was confirmed in copper foil layer when end surface (section) of laminated body was checked.

No crack was in the sample of heat cycle test measurement in Example 1 after the heat cycle test, and the evaluation was Good.

As described above, it has been shown that the resin sheet 10 in Example 1 had an excellent thermal conduction property. Further, the heat dissipation plate using the resin sheet 10 in Example 1 had an excellent thermal conduction property. Furthermore, it has been shown that the heat dissipation plate in Example 1 had an excellent heat cycle characteristic.

### Example 2 to Example 15 and Comparative Example 1 to Comparative Example 15

As illustrated in Table 1 and Table 2, a thermosetting resin composition was prepared by a similar method to that in Example 1 except that a kind and a content of each component included in the thermosetting resin composition were changed, and the resin sheet 10 was produced. For a filler included in the thermosetting resin composition from Comparative Example 1 to Comparative Example 7 illustrated in Table 2, a ratio between the first spherical filler and the second spherical filler was not able to be calculated, and thus “-” was indicated in a section of “FIRST SPHERICAL FILLER: SECOND SPHERICAL FILLER”. A storage elastic modulus of the thermosetting resin composition after curing that was prepared in each of the examples and each of the comparative examples was measured by the same method as the measurement method in Example 1. Measurement of thermal conductivity of the resin sheet produced in each of the examples and each of the comparative examples and a heat cycle test were performed by the same method as the test methods performed in Example 1. Note that a unit of the content in the tables is “part by weight” unless otherwise specified.

TABLE 1

[symbol]

[symbol]

indicates data missing or illegible when filed

TABLE 2

[symbol]

[symbol]

indicates data missing or illegible when filed

As illustrated in Table 1, it has been shown that the resin sheet 10 in Example 2 to Example 15 had an excellent thermal conduction property. Further, the heat dissipation plate using the resin sheet 10 in Example 2 to Example 15 had an excellent thermal conduction property. Furthermore, it has been shown that the heat dissipation plate in Example 2 to Example 15 had an excellent heat cycle characteristic.

Furthermore, peel strength, a dielectric breakdown voltage, and a dielectric breakdown voltage after a long-term wet heat test of the resin sheet 10 in Example 1 to Example 15 were measured, and adhesiveness and a dielectric breakdown voltage characteristic were evaluated. Example 1 is described below as an example.

### <Dielectric Breakdown Voltage>

### (Measurement Sample of Dielectric Breakdown Voltage)

A measurement sample of a dielectric breakdown voltage in Example 1 was produced as follows. First, the resin sheet 10 produced in Example 1, a rolled copper foil (BHY made by JX Nippon Mining & Metals Corp.) that had a thickness of 35 μm and was intended to represent the substrate 30 and the circuit 31, and an aluminum plate (A1100 made by Showa Denko K.K.) corresponding to the metal plate 21 and having a thickness of 1 mm were each prepared. Next, the rolled copper foil and the resin sheet 10 were laminated in such a way that a rough surface of the rolled copper foil and a resin surface of the resin sheet 10 were in contact. Next, the aluminum plate and the resin sheet 10 were laminated in such a way that one side of the aluminum plate was in contact with a resin surface being a surface opposite to the resin surface on which the rolled copper foil was laminated, and a laminated body was acquired. The acquired laminated body had a configuration in which the rolled copper foil, the resin sheet 10, and the aluminum plate were laminated in this order. Next, the laminated body was heated and pressurized in a condition of 185° C., 5 MPa, and 180 minutes. Furthermore, the laminated body was further heated for 5 hours in an oven at 160° C., and was then cooled. For the acquired laminated body, the rolled copper foil was etched in such a way as to have a circular shape having a diameter of 20 mm. Subsequently, the laminated body was washed in water and dried, and the measurement sample of a dielectric breakdown voltage was acquired. Note that the resin sheet 10 was used after the mold releasing PET film was peeled.

### (Measurement and Evaluation of Dielectric Breakdown Voltage)

As a dielectric breakdown testing machine, B-5120AT-2 made by Nippon Technart Inc. was used. In a state where the measurement sample of a dielectric breakdown voltage was immersed in oil at 25° C., voltage is applied between the rolled copper foil etched in the circular shape and the aluminum plate. The voltage was increased at a pace of 1 kV/0.5 sec, and the voltage when dielectric breakdown occurred was measured. This test was performed five times, an average value was calculated, and evaluation was performed by the following criteria. Note that the dielectric breakdown voltage is also referred to as a dielectric breakdown voltage before a long-term wet heat test.
Good: voltage is 2 kV or more, and
Poor: voltage is less than 2 kV.

The dielectric breakdown voltage in Example 1 was 3.5 kV, and the evaluation was Good. It has been shown that the resin sheet 10 in Example 1 had an excellent insulation property.

### <Peel Strength>

### (Measurement Sample of Peel Strength)

A laminated body acquired in the production process of the measurement sample of a dielectric breakdown voltage was separately prepared. For the laminated body, the rolled copper foil was etched in such a way as to have 10 mm wide×100 mm long. The laminated body after etching was washed in water and dried, and a measurement sample of peel strength in Example 1 was acquired.

### (Measurement and Evaluation of Peel Strength)

Autograph AGS-500 made by SHIMADZU CORPORATION was used as a measurement apparatus. The rolled copper foil was peeled in a direction at 90° (direction perpendicular to a main surface of the sample), and peel strength in a boundary surface between the rolled copper foil and the resin sheet 10 was measured. A test speed was set to 50 mm/min. The test was performed twice, and an average value was calculated.

Evaluation criteria were as follows.
Good: peel strength is 2 N/cm or more, and
Poor: peel strength is less than 2 N/cm.

The peel strength in Example 1 was 10 N/cm, and the evaluation was Good.

<Dielectric Breakdown Voltage after Long-Term Wet Heat Test>

An insulation property of the resin sheet 10 after a long-term wet heat test was evaluated by measuring a dielectric breakdown voltage of the resin sheet 10.

### (Measurement Sample of Dielectric Breakdown Voltage After Long-term Wet Heat Test)

A sample used for the evaluation was produced by the same method as the above-described method for producing the measurement sample of a dielectric breakdown voltage.

### (Measurement and Evaluation of Dielectric Breakdown Voltage After Long-term Wet Heat Test)

The measurement sample of a dielectric breakdown voltage after the long-term wet heat test was kept under an atmosphere of 85° C.×85% RH×1,000 hours, and then moisture adhering to a surface of the sample was wiped off, and measurement was performed in the same measurement condition as that of the dielectric breakdown voltage described above.

Evaluation criteria were as follows.
Good: voltage is 1 kV or more, and
Poor: voltage is less than 1 kV.

The dielectric breakdown voltage after the long-term wet heat test in Example 1 was 0.5 kV, and the evaluation was Poor.

As described above, it has been shown that the resin sheet 10 constituted by the thermosetting resin composition in Example 1 had a low dielectric breakdown voltage after the long-term wet heat test, but had a high dielectric breakdown voltage before the long-term wet heat test and had excellent adhesiveness to metal. Further, similarly to Example 1, a dielectric breakdown voltage, peel strength, and a dielectric breakdown voltage after a long-term wet heat test of the resin sheet 10 constituted by the thermosetting resin composition in Example 2 to Example 15 were also measured, and a dielectric breakdown voltage characteristic and adhesiveness were evaluated. The results are shown in Table 3.

TABLE 3

| EXAMPLE | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| DIELECTRIC | Good | Good | Good | Good | Good | Good | Poor | Good | Good | Good | Good | Good | Good | Good | Poor |
| BREAKDOWN | | | | | | | | | | | | | | | |
| LONG-TERM WET | | | | | | | | | | | | | | | |
| HEAT TEST (kV) | | | | | | | | | | | | | | | |
| VOLTAGE BEFORE | | | | | | | | | | | | | | | |
| PEEL STRENGTH | Good | Good | Good | Good | Good | Good | Good | Good | Good | Good | Good | Good | Good | Good | Good |
| (N/cm) | | | | | | | | | | | | | | | |
| DIELECTRIC | Poor | Good | Good | Good | Good | Good | Poor | Good | Good | Good | Good | Poor | Good | Good | Poor |
| BREAKDOWN | | | | | | | | | | | | | | | |
| VOLTAGE AFTER | | | | | | | | | | | | | | | |
| LONG-TERM WET | | | | | | | | | | | | | | | |
| HEAT TEST (kV) | | | | | | | | | | | | | | | |

From Table 3, for example, the resin sheet 10 constituted by the thermosetting resin composition including an ion scavenger in Example 2 had a high dielectric breakdown voltage before the long-term wet heat test, had a high dielectric breakdown voltage after the long-term wet heat test, and had high peel strength. From this, it has been shown that the resin sheet 10 in Example 2 had an excellent dielectric breakdown voltage characteristic and excellent adhesiveness.

Further, it has been shown that the resin sheet 10 in Example 3 to Example 6, Example 8 to Example 11, Example 13, and Example 14 also had an excellent dielectric breakdown voltage characteristic and excellent adhesiveness.

It has been shown from the results above that the resin sheet 10 in Example 1 to Example 15 had an excellent thermal conduction property and excellent adhesiveness. Further, the heat dissipation plate using the resin sheet 10 in Example 1 to Example 15 had an excellent thermal conduction property. Further, it has been shown that the heat dissipation plate 20 in Example 1 to Example 15 had an excellent heat cycle characteristic. Furthermore, it has been shown that the resin sheet 10 in Example 2 to Example 6, Example 8 to Example 11, Example 13, and Example 14 had an excellent dielectric breakdown voltage characteristic.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2023-066101, filed on Apr. 14, 2023, the entire disclosure of which is incorporated by reference herein.

### APPENDIX

### Appendix 1

A thermosetting resin composition comprising:
an epoxy resin;
a curing agent that cures the epoxy resin;
an ethylene acrylic copolymer having a glass transition temperature of −30° C. or lower and having a carboxy group in a side chain;
a first spherical filler having thermal conductivity of 20 W/m·K or more and an average particle diameter (D50) of 30 μm or more and 60 μm or less; and
a second spherical filler having thermal conductivity of 20 W/m·K or more and an average particle diameter (D50) of 1 μm or more and 10 μm or less, wherein
a total weight proportion between the first spherical filler and the second spherical filler is 84 weight % or more and 90 weight % or less with respect to 100 weight % of total solids,
a ratio between the first spherical filler and the second spherical filler is 55:45 to 85:15, and
a content of the ethylene acrylic copolymer is 700 parts by weight or more and 1,000 parts by weight or less with respect to 100 parts by weight of the epoxy resin.

### Appendix 2

The thermosetting resin composition according to appendix 1, wherein the first spherical filler is constituted by at least one kind selected from a group consisting of alumina, boron nitride, aluminum nitride, magnesium oxide, zinc oxide, and silicon nitride.

### Appendix 3

The thermosetting resin composition according to appendix 1 or 2, wherein the second spherical filler is constituted by at least one kind selected from a group consisting of alumina, boron nitride, aluminum nitride, magnesium oxide, zinc oxide, and silicon nitride.

### Appendix 4

The thermosetting resin composition according to any one of appendices 1 to 3, further comprising
an ion scavenger that captures an ion,
wherein a content of the ion scavenger is 40 parts by weight or more and 60 parts by weight or less with respect to 100 parts by weight of the epoxy resin.

### Appendix 5

The thermosetting resin composition according to any one of appendices 1 to 4, wherein thermal conductivity after curing is 2 W/m·K or more, a storage elastic modulus at −30° C. after curing is 7,000 MPa or less, a storage elastic modulus at 25° C. after curing is 10 MPa or more and 100 MPa or less, and a storage elastic modulus at 125° C. after curing is 1 MPa or more and 100 MPa or less.

### Appendix 6

A resin sheet comprising the thermosetting resin composition according to any one of appendices 1 to 5.

### Appendix 7

The resin sheet according to appendix 6, wherein a cured state is a semi-cured state.

### Appendix 8

A heat dissipation plate comprising:
a metal plate; and
a resin layer including the thermosetting resin composition according to any one of appendices 1 to 5,
wherein the resin layer is provided on at least one surface of the metal plate.

### Appendix 9

The heat dissipation plate according to appendix 8, wherein a cured state of the resin layer is a semi-cured state.

### Appendix 10

A method for manufacturing a resin sheet, the method comprising:
preparing the thermosetting resin composition according to any one of appendices 1 to 5;
providing, on a film, a resin layer constituted by the thermosetting resin composition; and
heating the film provided with the resin layer.

### Appendix 11

A method for manufacturing a heat dissipation plate, the method comprising:
laminating, on a metal plate, a resin layer of a resin sheet acquired by the method according to appendix 10; and
heating and pressurizing the metal plate on which the resin layer is laminated.

### Appendix 12

A method for manufacturing a heat dissipation plate, the method comprising:
preparing the thermosetting resin composition according to any one of appendices 1 to 5;
providing, on a metal plate, a resin layer constituted by the thermosetting resin composition; and
heating the metal plate provided with the resin layer.

### REFERENCE SIGNS LIST

10 Resin sheet
20 Heat dissipation plate
21 Metal plate
22 Fin
23 Resin layer
30 Substrate
31 Circuit
40 Electronic part

1. A thermosetting resin composition comprising:
an epoxy resin;
a curing agent that cures the epoxy resin;
an ethylene acrylic copolymer having a glass transition temperature of −30° C. or lower and having a carboxy group in a side chain;
a first spherical filler having thermal conductivity of 20 W/m·K or more and an average particle diameter (D50) of 30 μm or more and 60 μm or less; and
a second spherical filler having thermal conductivity of 20 W/m·K or more and an average particle diameter (D50) of 1 μm or more and 10 μm or less, wherein
a total weight proportion between the first spherical filler and the second spherical filler is 84 weight % or more and 90 weight % or less with respect to 100 weight % of total solids,
a ratio between the first spherical filler and the second spherical filler is 55:45 to 85:15, and
a content of the ethylene acrylic copolymer is 700 parts by weight or more and 1,000 parts by weight or less with respect to 100 parts by weight of the epoxy resin.

2. The thermosetting resin composition according to claim 1, wherein the first spherical filler is constituted by at least one kind selected from a group consisting of alumina, boron nitride, aluminum nitride, magnesium oxide, zinc oxide, and silicon nitride.

3. The thermosetting resin composition according to claim 1, wherein the second spherical filler is constituted by at least one kind selected from a group consisting of alumina, boron nitride, aluminum nitride, magnesium oxide, zinc oxide, and silicon nitride.

4. The thermosetting resin composition according to claim 1, further comprising
an ion scavenger that captures an ion,
wherein a content of the ion scavenger is 40 parts by weight or more and 60 parts by weight or less with respect to 100 parts by weight of the epoxy resin.

5. The thermosetting resin composition according to claim 1, wherein thermal conductivity after curing is 2 W/m·K or more, a storage elastic modulus at −30° C. after curing is 7,000 MPa or less, a storage elastic modulus at 25° C. after curing is 10 MPa or more and 100 MPa or less, and a storage elastic modulus at 125° C. after curing is 1 MPa or more and 100 MPa or less.

6. A resin sheet comprising the thermosetting resin composition according to claim 1.

7. The resin sheet according to claim 6, wherein a cured state is a semi-cured state.

8. A heat dissipation plate comprising:
a metal plate; and
a resin layer including the thermosetting resin composition according to claim 1,
wherein the resin layer is provided on at least one surface of the metal plate.

9. The heat dissipation plate according to claim 8, wherein a cured state of the resin layer is a semi-cured state.

10. A method for manufacturing a resin sheet, the method comprising:
preparing the thermosetting resin composition according to claim 1;
providing, on a film, a resin layer constituted by the thermosetting resin composition; and
heating the film provided with the resin layer.

11. A method for manufacturing a heat dissipation plate, the method comprising:
laminating, on a metal plate, a resin layer of a resin sheet acquired by the method according to claim 10; and
heating and pressurizing the metal plate on which the resin layer is laminated.

12. A method for manufacturing a heat dissipation plate, the method comprising:
preparing the thermosetting resin composition according to claim 1;
providing, on a metal plate, a resin layer constituted by the thermosetting resin composition; and
heating the metal plate provided with the resin layer.
